(19) United States
(12) Patent Application Publication
(10) Pub. No.: US 2016/0065594 A1
(43) Pub. Date: Mar. 3, 2016

(54) INTRUSION DETECTION PLATFORM

(71) Applicant: Verizon Patent and Licensing Inc., Arlington, VA (US)

(72) Inventors: Ashok N. Srivastava, Mountain View, CA (US); Yong Gao, Fremont, CA (US); Yian Xu, Los Gatos, CA (US)

(21) Appl. No.: 14/472,886

(22) Filed: Aug. 29, 2014

(51) Int. Cl. H04L 29/06

(52) U.S. Cl. CPC H04L 63/145; H04L 63/1458; H04L 63/1433; H04L 2463/141

(57) ABSTRACT

A device receives user information associated with a user of a user device that is associated with a network, and creates a user profile, associated with the user, based on the user information. The device determines threats to the network, by the user, based on the user profile. The threats to the network include insider threats, advanced persistent threats, bring your own device (BYOD) threats, cloud security threats, malware threats, and/or denial of service (DoS) threats. The device stores or presents, for display, information associated with the determined threats to the network by the user.

### BACKGROUND

Network security threats may include insider threats (e.g., by employees in an organization), advanced persistent threats (e.g., spoofing or stealing information at a slow rate over a long period of time), bring your own device (BYOD) threats (e.g., threats caused by employee negligence), cloud security threats, malware threats, denial of service (DoS) threats, or the like. Such network security threats may cost organizations a significant amount of money. A network provider may monitor such network security threats via an intrusion detection system.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of one or more devices of FIG. 2;

FIG. 4 depicts a flow chart of an example process for detecting intrusions associated with networks and/or users of the networks; and

FIGS. 5A-5E are diagrams of an example relating to the example process shown in FIG. 4.

### DETAILED DESCRIPTION OF PREFERRED EMBODIMENTS

The following detailed description refers to the accompanying drawings. The same reference numbers in different drawings may identify the same or similar elements.

An intrusion detection system is a security management system for computers and/or networks. An intrusion detection system gathers and analyzes information from various areas within computers and/or networks to identify possible security breaches, such as intrusions (e.g., attacks from outside an organization) and misuse (e.g., attacks from within an organization). Intrusion detection functions include monitoring and analyzing user and system activities, analyzing system configurations and vulnerabilities, assessing system and file integrity, recognizing patterns typical of attacks, tracking user policy violations, or the like. However, typical intrusion detection systems address a particular network security threat, and do not address other network security threats.

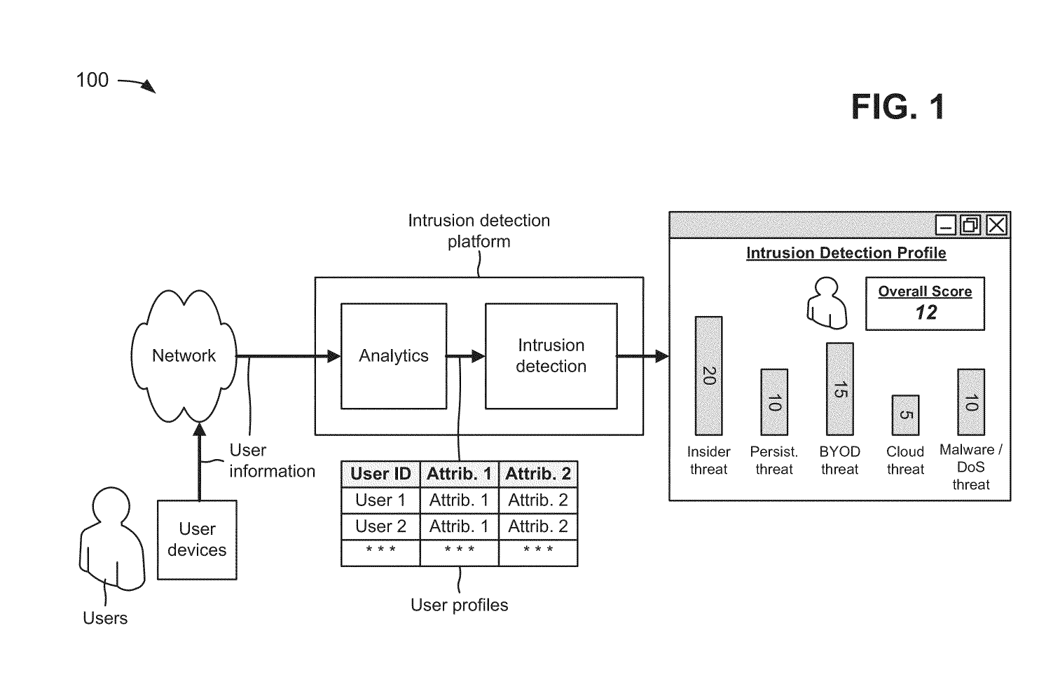

FIG. 1 is a diagram of an overview of an example implementation 100 described herein. In example implementation 100, assume that an intrusion detection platform is associated with a network that supports multiple user devices associated with users. The intrusion detection platform may receive user information (e.g., via the network). The user information may be generated by the multiple user devices, and may include information associated with the user devices and the users, network information, or the like. The user information may be stored in or generated by the user devices and/or a network resource (e.g., a server device), and provided to the intrusion detection platform.

The intrusion detection platform may include an analytics component and an intrusion detection component. The analytics component may create user profiles for the users based on the user information. For example, the analytics component may create a user profile, for a particular user, that includes a user identifier (ID) (e.g., a unique user name, a user identification number, or the like) and multiple attributes associated with the particular user (e.g., demographic information, location information, time information, user device information, or the like). The analytics component may provide the user profiles to the intrusion detection component. The analytics component may continuously receive updated user information from the user devices, and may update the user profiles based on the updated user information. The analytics component may provide the updated user profiles to the intrusion detection component.

The intrusion detection component may compare the updated user profiles with previously received user profiles in order to determine any deviations between the updated user profiles and the previously received user profiles. The deviations may enable the intrusion detection component to determine different types of security threats to the network. For example, the intrusion detection component may determine (e.g., based on the deviations) whether a particular user is involved in insider threats to the network, advanced persistent threats to the network, BYOD threats to the network, cloud security threats to the network, malware threats to the network, denial of service (e.g., distributed denial of service (DDoS), telephony DoS (TDoS), or the like) threats to the network, or the like.

The intrusion detection component may consider multiple network security threats for each user, and may calculate an intrusion detection score for each user based on information associated with the multiple network security threats. For example, the intrusion detection component may calculate, for a particular user, an insider threat score of “20,” an advanced persistent threat score of “10,” a BYOD threat score of “15,” a cloud security threat score of “5,” and a malware/DoS threat score of “10.” Based on such calculations, the intrusion detection component may determine, for the particular user, an intrusion detection score of “12” (e.g., an average of the threat scores). The intrusion detection platform may store, may display, and/or may provide for display (e.g., on another device) the calculated threat scores and the intrusion detection score for each user. For example, as shown in FIG. 1, the intrusion detection platform may display an intrusion detection profile that includes the calculated threat scores (e.g., “20,” “10,” “15,” “5,” and “10”) and the intrusion detection score (e.g., “12”) for the particular user.

Systems and/or methods described herein may provide an intrusion detection platform that addresses multiple network security threats for each user of a network based on usage of the network and/or attributes of the users. The systems and/or methods may discover threats and vulnerabilities at a user level, a user device level, a network level, a sub-network level, a system level, or the like through automated discovery of anomalies associated with network usage. The systems and/or methods may enable vulnerability discovery, assessment, threat detection, and behavioral monitoring through data mining of network usage patterns. By preventing network security threats, the systems and/or methods may provide cost savings to entities associated with a network.

As used herein, the term user is intended to be broadly interpreted to include a user device, or a user of a user device. The term entity, as used herein, is intended to be broadly interpreted to include a business, an organization, a government agency, or the like.

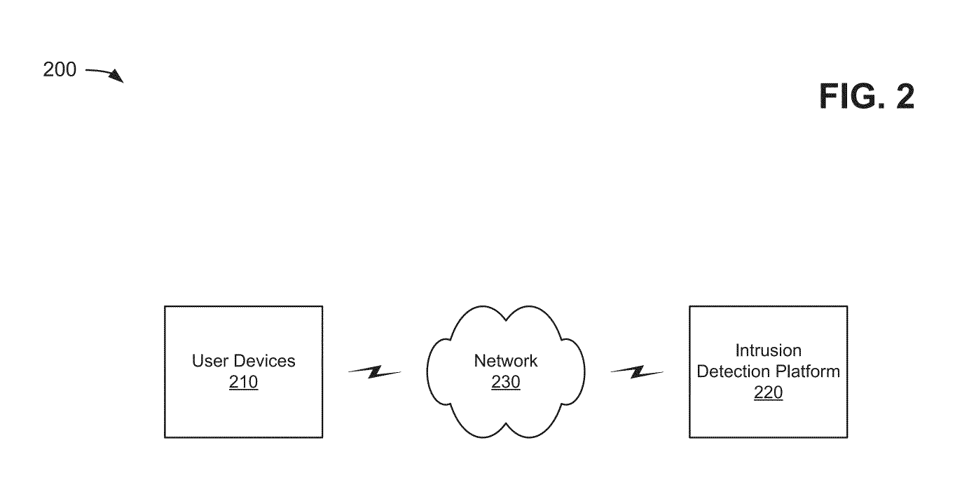

FIG. 2 is a diagram of an example environment 200 in which systems and/or methods described herein may be implemented. As illustrated, environment 200 may include user devices 210, an intrusion detection platform 220, and a network 230. Devices/networks of environment 200 may interconnect via wired connections, wireless connections, or a combination of wired and wireless connections.

User device 210 may include a device that is capable of communicating over network 230 with intrusion detection platform 220. In some implementations, user device 210 may include a radiotelephone; a personal communications services (PCS) terminal that may combine, for example, a cellular radiotelephone with data processing and data communications capabilities; a smart phone; a configured television; a laptop computer; a tablet computer; a global positioning system (GPS) device; a gaming device; a set-top box (STB); or another type of computation and communication device. In some implementations, user device 210 may be associated with a service provider that manages and/or operates network 230, such as, for example, a telecommunication service provider, a television service provider, an Internet service provider, a wireless service provider, or the like.

Intrusion detection platform 220 may include one or more personal computers, one or more workstation computers, one or more server devices, one or more virtual machines (VMs) provided in a cloud computing network, and/or one or more other types of computation and communication devices. In some implementations, intrusion detection platform 220 may be associated with a service provider that manages and/or operates network 230, such as, for example, a telecommunication service provider, a television service provider, an Internet service provider, a wireless service provider, or the like.

In some implementations, intrusion detection platform 220 may receive user information associated with users of user devices 210 and network 230, and may create user profiles based on the user information. Intrusion detection platform 220 may determine insider threats, advanced persistent threats, BYOD threats, cloud security threats, malware threats, DDoS and/or TDoS threats, or the like to network 230 for each user based on the user profiles. In some implementations, intrusion detection platform 220 may calculate scores for the determined insider threats, advanced persistent threats, BYOD threats, cloud security threats, malware threats, DDoS/TDoS threats, or the like. Intrusion detection platform 220 may calculate an intrusion detection score for each user based on the scores associated with the determined threats. Intrusion detection platform 220 may store and/or display the intrusion detection scores and information associated with the determined threats. In some implementations, a user of intrusion detection platform 220 may view intrusion detection scores and/or information associated with the determined threats for one or more users of user devices 210.

Network 230 may include a network, such as a local area network (LAN), a wide area network (WAN), a metropolitan area network (MAN), a telephone network, such as the Public Switched Telephone Network (PSTN) or a cellular network, an intranet, the Internet, a fiber optic network, a satellite network, a cloud computing network, or a combination of networks. In some implementations, network 230 may be associated with a service provider (e.g., and be referred to as a service provider network) that manages and/or operates network 230, such as, for example, a telecommunication service provider, a television service provider, an Internet service provider, a wireless service provider, or the like.

In some implementations, the cellular network may include a fourth generation (4G) cellular network that includes an evolved packet system (EPS). The EPS may include a radio access network (e.g., referred to as a long term evolution (LTE) network), a wireless core network (e.g., referred to as an evolved packet core (EPC) network), an Internet protocol (IP) multimedia subsystem (IMS) network, and a packet data network (PDN). The LTE network may be referred to as an evolved universal terrestrial radio access network (E-UTRAN), and may include one or more base stations. The EPC network may include an all-Internet protocol (IP) packet-switched core network that supports high-speed wireless and wireline broadband access technologies. The EPC network may allow user devices 210 to access various services by connecting to the LTE network, an evolved high rate packet data (eHRPD) radio access network (RAN), and/or a wireless local area network (WLAN) RAN. The IMS network may include an architectural framework or network (e.g., a telecommunications network) for delivering IP multimedia services. The PDN may include a communications network that is based on packet switching. In some implementations, the cellular network may provide location information (e.g., latitude and longitude coordinates) associated with user devices 210. For example, the cellular network may determine a location of user device 210 based on triangulation of signals, generated by user device 210 and received by multiple base stations, with prior knowledge of the base stations.

The number of devices and/or networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

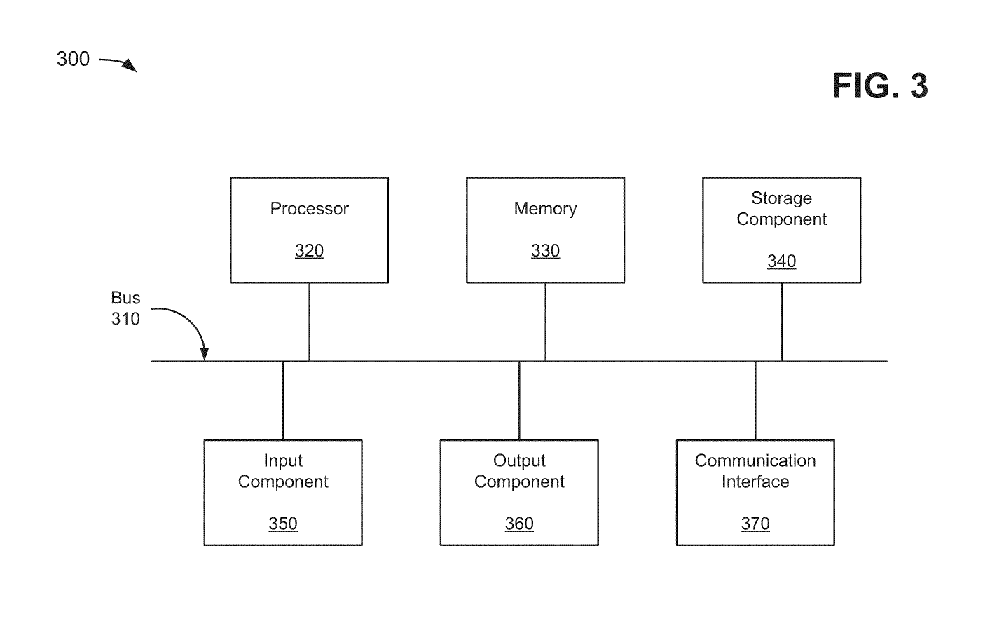

FIG. 3 is a diagram of example components of a device 300 that may correspond to one or more of the devices of environment 200. In some implementations, each of the devices of environment 200 may include one or more devices 300 or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 may include a processor (e.g., a central processing unit (CPU), a graphics processing unit (GPU), an accelerated processing unit (APU), or the like), a microprocessor, and/or any processing component (e.g., a field-programmable gate array (FPGA), an application-specific integrated circuit (ASIC), or the like) that interprets and/or executes instructions. Memory 330 may include a random access memory (RAM), a read only memory (ROM), and/or another type of dynamic or static storage device (e.g., a flash memory, a magnetic memory, an optical memory, or the like) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, or the like), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, or the like). Additionally, or alternatively, input component 350 may include a sensor for sensing information (e.g., a global positioning system (GPS) component, an accelerometer, a gyroscope, an actuator, or the like). Output component 360 may include a component that provides output information from device 300 (e.g., a display, a speaker, one or more light-emitting diodes (LEDs), or the like).

Communication interface 370 may include a transceiver-like component (e.g., a transceiver, a separate receiver and transmitter, or the like) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 is provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

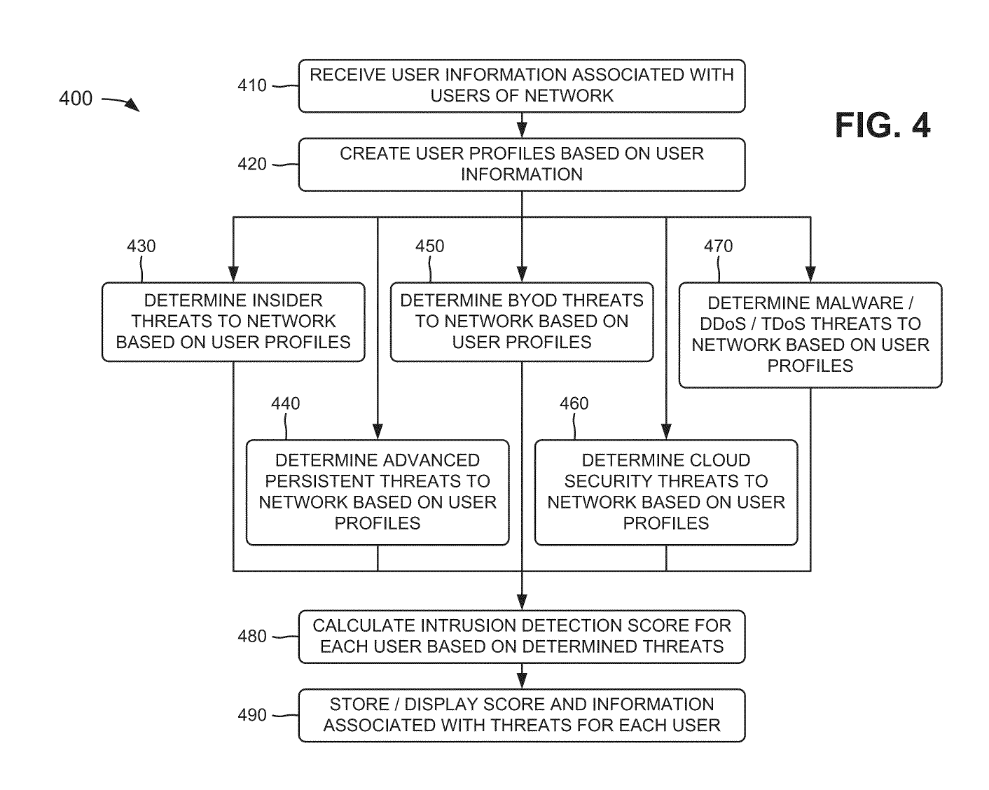

FIG. 4 is a flow chart of an example process 400 for detecting intrusions associated with networks and/or users of the networks. In some implementations, one or more process blocks of FIG. 4 may be performed by intrusion detection platform 220. In some implementations, one or more process blocks of FIG. 4 may be performed by another device or a group of devices separate from or including intrusion detection platform 220, such as user device 210.

As shown in FIG. 4, process 400 may include receiving user information associated with users of a network (block 410). For example, intrusion detection platform 220 may receive, from user devices 210, user information associated with users of network 230. In some implementations, the user information may include information associated with user devices 210 (e.g., types of user devices 210, model numbers of user devices 210, or the like); information associated with the users of user devices 210 (e.g., account information, demographic information, or the like); network information (e.g., information associated with network resources of network 230 utilized by user devices 210); usage information associated with network 230 by user devices 210; content accessed by user devices 210; transactions associated with user devices 210; clickstream information associated with user devices 210; location information associated with user devices 210; time information associated with user devices 210; or the like.

The clickstream information may include information associated with portions of user interfaces that users select (e.g., or click on) while web browsing (e.g., accessing content) or while using a software application. The location information may include information associated with locations (e.g., global positioning system (GPS) coordinates, cellular triangulation locations, or the like) of user devices 210 when content is accessed by user devices 210. In some implementations, the location information may include information associated with a current location of user device 210, proximity of user device 210 to something (e.g., another user device 210, a store, or the like), travel patterns of user device 210 (e.g., stops at a particular coffee shop on his way to work each day, drives home from work at 6:00 PM, a route traveled by user device 210, or the like), travel information (e.g., relating to an upcoming trip), a current location of another user device 210 (e.g., of a family member), or the like. The time information may include information associated with times when user devices 210 access the content (e.g., dates and times when the content is accessed, an amount of time the user devices are performing online activities, such as browsing, or the like). In some implementations, the time information may include information associated with holidays, birthday(s), meetings, time of day, time of a week, or the like.

In some implementations, user devices 210 may receive user information from users when the users register user devices 210 for a service (e.g., a telephone service, an Internet service, a television service, or the like) and may include registration information, such as names, home addresses, contact information, account types, demographic information, gender information, or the like. In some implementations, intrusion detection platform 220 may continuously receive the user information from user devices 210 and/or network 230. In some implementations, intrusion detection platform 220 may periodically (e.g., hourly, daily, weekly, or the like) receive the user information from user devices 210 and/or network 230. In some implementations, the user information may be stored in and/or generated by user devices 210 and/or a network resource (e.g., a server device) of network 230, and continuously and/or periodically provided to intrusion detection platform 220.

In some implementations, user device 210 may include an application that monitors, with the user's approval, actions taken in relation to user device 210. The application, on user device 210, may continuously transmit the monitored information (e.g., the user information and information identifying the user) to intrusion detection platform 220, or may cause user device 210 to store the monitored information and provide the monitored information when requested by intrusion detection platform 220 (e.g., during times when traffic of network 230 is below a threshold).

As further shown in FIG. 4, process 400 may include creating user profiles based on the user information (block 420). For example, intrusion detection platform 220 may create user profiles, for the users, based on the user information. In some implementations, a user profile, for a particular user, may include a user identifier (ID) (e.g., a unique user name, a user identification number, or the like) and multiple attributes associated with the particular user (e.g., demographic information, location information, time information, user device information, interests, behavior, purchases made, or the like). For example, assume that a particular user (e.g., Susan) utilizes a mobile user device 210 (e.g., a smart phone) at work, and that location information associated with the smart phone indicates that Susan is at a particular location (e.g., at an office building) during the week. Further, assume that Susan utilizes the smart phone to access a company network. In such an example, intrusion detection platform 220 may create a user profile for Susan that includes information indicating interests of Susan (e.g., Susan utilizes her own smart phone for work purposes), behavior of Susan (e.g., Susan works at the office building during the week), information received by Susan (e.g., Susan receives information from the company network via the smart phone), or the like.

In another example, assume that a particular user (e.g., Fred) utilizes a particular user device 210 (e.g., a tablet computer) to access a company email account, and that Fred utilizes the tablet computer to send emails via the email account. Further, assume that Fred utilizes the tablet computer to receive emails from customers via the email account. In such an example, intrusion detection platform 220 may create a user profile for Fred that includes information indicating interests of Fred (e.g., Fred is interested in the company email account), behavior of Fred (e.g., Fred sends emails via the email account), information received by Fred (e.g., Fred receives emails via the email account), or the like.

In still another example, assume that a particular user (e.g., Jane) is network administrator for a company, and utilizes a mobile user device 210 (e.g., a tablet) when accessing a company network and to perform service on the company network. Further, assume that Jane utilizes the tablet to receive information associated with the company network. In such an example, intrusion detection platform 220 may create a user profile for Jane that includes information indicating interests of Jane (e.g., Jane is interested in accessing the company network), behavior of Jane (e.g., Jane accesses the company network and performs service on the company network via the tablet), information received by Jane (e.g., Jane receives golf lesson information associated with the company network via the tablet), or the like.

As further shown in FIG. 4, process 400 may include determining insider threats to the network based on the user profiles (block 430). For example, intrusion detection platform 220 may determine insider threats to network 230 based on the user profiles. In some implementations, the insider threats may include network breaches by privileged users (e.g., system administrators, database administrators, network administrators, and/or other people responsible for maintaining a network of an entity), cyber-criminals (e.g., attempting to compromise insider accounts to steal information), or the like. In some implementations, intrusion detection platform 220 may determine typical user profiles (e.g., that include typical behavior, usage patterns, interests, or the like of the users of user devices 210) based on the user information, and may receive updated user information from user devices 210. Intrusion detection platform 220 may determine updated user profiles based on the updated user information, and may compare the updated user profiles and the typical user profiles. If the comparison between the updated user profiles and the typical user profiles indicates differences between any of the updated user profiles and corresponding typical user profiles, intrusion detection platform 220 may determine whether the differences are due to insider threats.

For example, assume that a typical user profile for a particular user indicates that the particular user is a network administrator (e.g., of network 230) that views web sites associated with motorcycles while at work for a company. Further, assume that the particular user gets fired and the company forgets to void the particular user's login credentials. The particular user may log into the company's network, and may perform some malicious act (e.g., introduce bugs into source code, delete files and backups, or the like). Intrusion detection platform 220 may capture the malicious act in an updated user profile for the particular user, and may identify the malicious act as an insider threat based on a comparison of the typical user profile and the updated user profile.

In some implementations, intrusion detection platform 220 may utilize machine learning algorithms to determine insider threats to network 230 based on the user profiles. In some implementations, the machine learning algorithms may include the construction and study of systems that can learn from information, such as the user profiles. The machine learning algorithms may include, for example, decision tree learning, association rule learning, artificial neural networks, inductive logic programming, support vector machines, clustering, Bayesian networks, representation learning, similarity learning, sparse dictionary learning, or the like.

Decision tree learning may utilize a decision tree as a predictive model that maps observations about an item (e.g., a typical user profile) to conclusions about the item's target (e.g., an updated user profile). Association rule learning may include a method for discovering relations between variables (e.g., the typical user profiles and the updated user profiles). An artificial neural network may include non-linear statistical data modeling tools, and may model complex relationships between inputs (e.g., the typical user profiles) and outputs (e.g., the updated user profiles), to find patterns in data, or to capture statistical structure in an unknown joint probability distribution between observed variables.

Inductive logic programming may utilize logic programming as a uniform representation for input examples, background knowledge, and/or hypotheses. Given known background knowledge and a set of examples represented as a logical database of facts (e.g., the typical user profiles), inductive logic programming may derive a hypothesized logic program that includes positive examples (e.g., the updated user profiles). A support vector machine may include a set of related supervised learning methods used for classification and regression. Given a set of training examples (e.g., the typical user profiles), each marked as belonging to one of two categories, a support vector machine may create a model that predicts whether a new example (e.g., the updated user profiles) falls into one category or the other.

Clustering may include an assignment of a set of observations (e.g., the typical user profiles) into subsets or clusters so that observations within a same cluster may be similar according to a particular criterion, while observations within different clusters may be dissimilar. In some implementations, clustering may include one or more of the following metrics: Euclidean distance, squared Euclidean distance, Manhattan distance, maximum distance, Mahalanobis distance, cosine similarity, or the like.

A Bayesian network may include a probabilistic graphical model that represents a set of random variables and conditional independencies via a directed acyclic graph (DAG). For example, the Bayesian network may represent probabilistic relationships between the typical user profiles and the updated user profiles.

Representation learning may attempt to preserve information (e.g., the typical user profiles), but may transform the information in a way that makes the information useful. For example, representation learning may perform a pre-processing step before performing classification or predictions, which may permit reconstruction of unknown information. Similarity learning may utilize pairs of examples that are considered similar and pairs of less similar examples, and may determine a similarity function (e.g., a distance metric function) that can predict if new examples are similar. In sparse dictionary learning, data may be represented as a linear combination of basis functions, and coefficients may be assumed to be sparse.

In some implementations, intrusion detection platform 220 may assign weights (e.g., values, percentages, or the like) to different information (e.g., attributes) associated with the user profiles (e.g., the typical user profiles and the updated user profiles), such as interests (e.g., sports, weather, news, or the like) associated with users, behavior (e.g., watch sports on television, shop online, or the like) associated with the users, network usage (e.g., low, medium, or high data usage, or the like) by the users, or the like. In some implementations, intrusion detection platform 220 may calculate a threat score for each of the user profiles based on the assigned weights. Intrusion detection platform 220 may compare a threat score for a typical user profile with a threat score of a corresponding updated user profile in order to identify differences between the typical user profile and the updated user profile (e.g., non-matching threat scores may be indicative of differences and network security threats).

For example, assume that intrusion detection platform 220 assigns a weight of 0.3 to interests associated with the users, a weight of 0.9 to behavior associated with the users, and a weight of 0.1 to the network usage by the users. Further, intrusion detection platform 220 may create a typical user profile (e.g., X1) for a particular user based on the user information, and may calculate a threat score of 0.8 for the typical user profile X1. Intrusion detection platform 220 may receive updated user information, and may create an updated user profile (e.g., X2) for the particular user based on the updated user information. Intrusion detection platform 220 may calculate a threat score of 0.6 for the updated user profile X2, and may identify a difference between the calculated threat scores (e.g., 0.8 versus 0.6). Intrusion detection platform 220 may determine that the difference between the calculated threat scores is due to insider threat activities associated with the particular user.

As further shown in FIG. 4, process 400 may include determining advanced persistent threats to the network based on the user profiles (block 440). For example, intrusion detection platform 220 may determine advanced persistent threats to network 230 based on the user profiles. In some implementations, the advanced persistent threats may include a set of stealthy and continuous computer hacking processes that target a specific entity over a long period of time. As the name implies, an advanced persistent threat includes three major elements: advanced, persistent, and threat. The advanced element may include sophisticated techniques (e.g., using malware) to exploit vulnerabilities in networks. The persistent element suggests that an external control is continuously monitoring and extracting information from a specific target. The threat element indicates human involvement in orchestrating an attack on a network.

In some implementations, intrusion detection platform 220 may determine typical user profiles based on the user information, and may determine updated user profiles based on the updated user information. If a comparison between the updated user profiles and the typical user profiles indicates differences between any of the updated user profiles and corresponding typical user profiles, intrusion detection platform 220 may determine whether the differences are due to advanced persistent threats. For example, assume that a typical user profile for a particular user indicates that the particular user is an employee with an email account for a company. Further, assume that the particular user receives an email with a malicious virus that siphons source code from the company's network slowly over time. Intrusion detection platform 220 may capture activities associated with the malicious virus in an updated user profile for the particular user (e.g., since the particular user's user device 210 is siphoning source code, which is captured in the updated user profile), and may identify the malicious virus as an advanced persistent threat based on a comparison of the typical user profile and the updated user profile.

In some implementations, intrusion detection platform 220 may utilize machine learning algorithms to determine advanced persistent threats to network 230 based on the user profiles. In some implementations, intrusion detection platform 220 may assign weights to different information associated with the typical user profiles and the updated user profiles. In some implementations, intrusion detection platform 220 may calculate a threat score for each of the typical user profiles and the updated user profiles based on the assigned weights. Intrusion detection platform 220 may compare a threat score for a typical user profile with a threat score of a corresponding updated user profile in order to identify differences between the typical user profile and the updated user profile (e.g., non-matching threat scores may be indicative of differences and network security threats). For example, intrusion detection platform 220 may determine that the difference between the calculated threat scores is due to advanced persistent threat activities associated with a particular user.

As further shown in FIG. 4, process 400 may include determining BYOD threats to the network based on the user profiles (block 450). For example, intrusion detection platform 220 may determine BYOD threats to network 230 based on the user profiles. BYOD may refer companies permitting employees to bring personally owned devices (e.g., notebooks, smart phones, tablets, or the like) into the workplace and to connect to the companies' networks. While there are numerous benefits to BYOD (e.g., it is cheaper for companies, employees take much better care of their own equipment, or the like), there are also risks in the form of BYOD threats. In some implementations, the BYOD threats may include software bugs (e.g., viruses, malware, or the like); lost devices (e.g., when an employee loses a device used for BYOD, the device is a risk until the device is either recovered or remotely wiped); buggy applications installed on a BYOD device (e.g., application vulnerabilities may deliberately or accidentally leak company data); malicious applications installed on a BYOD device (e.g., applications that may perform malicious acts); rooting or jailbreaking a BYOD device (e.g., procedures that undo security features placed on the BYOD device by the manufacturer); or the like.

In some implementations, intrusion detection platform 220 may determine typical user profiles based on the user information, and may determine updated user profiles based on the updated user information. If a comparison between the updated user profiles and the typical user profiles indicates differences between any of the updated user profiles and corresponding typical user profiles, intrusion detection platform 220 may determine whether the differences are due to BYOD threats. For example, assume that a typical user profile for a particular user indicates that the particular user is an employee with that utilizes a personal smart phone to access a company network. Further, assume that the smart phone is infected with malware that steals personal, financial, and business information from the company network. Intrusion detection platform 220 may capture activities associated with the malware in an updated user profile for the particular user, and may identify the malware as a BYOD threat based on a comparison of the typical user profile and the updated user profile.

In some implementations, intrusion detection platform 220 may utilize machine learning algorithms to determine BYOD threats to network 230 based on the user profiles. In some implementations, intrusion detection platform 220 may assign weights to different information associated with the typical user profiles and the updated user profiles. In some implementations, intrusion detection platform 220 may calculate a threat score for each of the typical user profiles and the updated user profiles based on the assigned weights. Intrusion detection platform 220 may compare a threat score for a typical user profile with a threat score of a corresponding updated user profile in order to identify differences between the typical user profile and the updated user profile (e.g., non-matching threat scores may be indicative of differences and network security threats). For example, intrusion detection platform 220 may determine that the difference between the calculated threat scores is due to BYOD threat activities associated with a particular user.

As further shown in FIG. 4, process 400 may include determining cloud security threats to the network based on the user profiles (block 460). For example, intrusion detection platform 220 may determine cloud security threats to network 230 based on the user profiles. In some implementations, the cloud security threats may include abuse and nefarious use of cloud computing (e.g., by allowing users to register for cloud services anonymously, cloud computing providers permit spammers, malicious code authors, and other criminals to conduct malicious activities without being identified); insecure application programming interfaces (APIs) (e.g., cloud computing providers provide a set of software APIs that customers use to manage and interact with cloud services, and the security and availability of general cloud services is dependent upon the security of these APIs.); shared technology vulnerabilities (e.g., cloud computing providers share infrastructure with components that were not designed to offer strong isolation properties for a multi-tenant architecture); data loss and/or leakage (e.g., the threat of data compromise due to insufficient protections in the cloud, such as insufficient authentication, authorization, and audit (AAA) controls, inconsistent use of encryption and software keys, operational failures, or the like); account, service, and/or traffic hijacking (e.g., attack methods, such as phishing, fraud, and exploitation of software vulnerabilities, in the cloud may enable an attacker to gain access to credentials, eavesdrop on activities and transactions, manipulate data, return falsified information, redirect clients to illegitimate sites, or the like); unknown risk profile (e.g., versions of software, code updates, security practices, vulnerability profiles, intrusion attempts, security design, network intrusion logs, redirection attempts and/or successes, or the like may be shared with unknown users); or the like.

In some implementations, intrusion detection platform 220 may determine typical user profiles based on the user information, and may determine updated user profiles based on the updated user information. If a comparison between the updated user profiles and the typical user profiles indicates differences between any of the updated user profiles and corresponding typical user profiles, intrusion detection platform 220 may determine whether the differences are due to cloud security threats. For example, assume that a typical user profile for a particular user indicates that the particular user is a customer that accesses a cloud computing network. Further, assume that the particular user has stolen credentials that enable the particular user to eavesdrop on activities and transactions of other customers. Intrusion detection platform 220 may capture the malicious activities associated with the particular user in an updated user profile for the particular user, and may identify the malicious activities as a cloud security threat based on a comparison of the typical user profile and the updated user profile.

In some implementations, intrusion detection platform 220 may utilize machine learning algorithms to determine cloud security threats to network 230 based on the user profiles. In some implementations, intrusion detection platform 220 may assign weights to different information associated with the typical user profiles and the updated user profiles. In some implementations, intrusion detection platform 220 may calculate a threat score for each of the typical user profiles and the updated user profiles based on the assigned weights. Intrusion detection platform 220 may compare a threat score for a typical user profile with a threat score of a corresponding updated user profile in order to identify differences between the typical user profile and the updated user profile (e.g., non-matching threat scores may be indicative of differences and network security threats). For example, intrusion detection platform 220 may determine that the difference between the calculated threat scores is due to cloud security threat activities associated with a particular user.

As further shown in FIG. 4, process 400 may include determining malware, DDoS, and/or TDoS threats to the network based on the user profiles (block 470). For example, intrusion detection platform 220 may determine malware, DDoS, and/or TDoS threats to network 230 based on the user profiles. In some implementations, the malware threats may include any software used to disrupt computer operation, gather sensitive information, gain access to private computer networks, or the like. Malware can appear in the form of executable code, scripts, active content, and other software, and may include computer viruses, worms, Trojan horses, ransomware, spyware, adware, scareware, and other malicious programs. In some implementations, the DDoS threats may include a type of DoS attack where multiple compromised systems (e.g., which are usually infected with a Trojan horse) are used to target a single system causing a DoS attack (e.g., an attempt to make a machine or network unavailable to its intended users). In some implementations, a TDoS may include attack that launches a high volume of calls against a target network in order to prevent the network from receiving legitimate calls.

In some implementations, intrusion detection platform 220 may determine typical user profiles based on the user information, and may determine updated user profiles based on the updated user information. If a comparison between the updated user profiles and the typical user profiles indicates differences between any of the updated user profiles and corresponding typical user profiles, intrusion detection platform 220 may determine whether the differences are due to malware, DDoS, and/or TDoS threats. For example, assume that a typical user profile for a particular user indicates that the particular user is an employee that utilizes a company's network via a tablet computer. Further, assume that the tablet computer has been infected with a virus that causes network information to be deleted. Intrusion detection platform 220 may capture the malicious activities associated with the tablet computer in an updated user profile for the particular user, and may identify the malicious activities as a malware threat based on a comparison of the typical user profile and the updated user profile.

In some implementations, intrusion detection platform 220 may utilize machine learning algorithms to determine malware, DDoS, and/or TDoS threats to network 230 based on the user profiles. In some implementations, intrusion detection platform 220 may assign weights to different information associated with the typical user profiles and the updated user profiles. In some implementations, intrusion detection platform 220 may calculate a threat score for each of the typical user profiles and the updated user profiles based on the assigned weights. Intrusion detection platform 220 may compare a threat score for a typical user profile with a threat score of a corresponding updated user profile in order to identify differences between the typical user profile and the updated user profile (e.g., non-matching threat scores may be indicative of differences and network security threats). For example, intrusion detection platform 220 may determine that the difference between the calculated threat scores is due to malware, DDoS, and/or TDoS threat activities associated with a particular user.

As further shown in FIG. 4, process 400 may include calculating an intrusion detection score for each user based on the determined threats (block 480). For example, intrusion detection platform 220 may calculate an intrusion detection score for each user of user devices 210 based on the determined threats (e.g., the insider threats, the advanced persistent threats, the BYOD threats, the cloud security threats, the malware threats, the DDoS threats, and/or the TDoS threats) for each user. In some implementations, intrusion detection platform 220 may calculate threat scores for each of the determined threats for each user, and may utilize the threat scores to calculate the intrusion detection score for each user. In some implementations, intrusion detection platform 220 may perform mathematical operations on the threat scores associated with the determined threats in order to calculate the intrusion detection score for each user. For example, intrusion detection platform 220 may calculate a sum, a product, an average, a median, a mean, a normal distribution, or the like of the threat scores associated with the determined threats in order to calculate the intrusion detection score for each user.

In some implementations, intrusion detection platform 220 may assign weights (e.g., values, percentages, or the like) to different threat scores associated with the determined threats for each user. In some implementations, intrusion detection platform 220 may calculate the intrusion detection score for each user based on the threat scores and the assigned weights.

For example, assume that intrusion detection platform 220 assigns a weight of 0.3 to the threat score for the insider threats, a weight of 0.6 to the threat score for the advanced persistent threats, a weight of 0.4 to the threat score for the BYOD threats, a weight of 0.7 to the threat score for the cloud security threats, and a weight of 0.1 to the threat score for the malware, DDoS, and/or TDoS threats. Further, assume that intrusion detection platform 220 calculates a threat score of “20” for the insider threats associated with a particular user, a threat score of “30” for the advanced persistent threats associated with the particular user, a threat score of “10” for the BYOD threats associated with the particular user, a threat score of “50” for the cloud security threats associated with the particular user, and a threat score of “80” for the malware, DDoS, and/or TDoS threats associated with the particular user. In such an example, intrusion detection platform 220 may calculate an intrusion detection score of “71” (e.g., 0.3×20+0.6×30+0.4×10+0.7×50+0.1×80=71) for the particular user.

As further shown in FIG. 4, process 400 may include storing and/or providing for display the intrusion detection score and information associated with the determined threats for each user (block 490). For example, intrusion detection platform 220 may store the intrusion detection score and information (e.g., the threat scores) associated with the determined threats, for each user, in storage (e.g., memory 330 and/or storage component 340, FIG. 3) associated with intrusion detection platform 220. In some implementations, intrusion detection platform 220 may provide the intrusion detection score and the information associated with the determined threats, for each user, for display to a user associated with intrusion detection platform 220. In some implementations, intrusion detection platform 220 may provide the intrusion detection score and the information associated with the determined threats, for each user, for display to a user associated with a device other than intrusion detection platform 220.

In some implementations, intrusion detection platform 220 may provide, for display, the intrusion detection score and the information associated with the determined threats for a particular user in comparison with the intrusion detection scores and the information associated with the determined threats for one or more other users. In some implementations, intrusion detection platform 220 may provide, for display, the comparison in a textual format (e.g., in a table, a chart, or the like), a graphical format (e.g., a bar chart, a histogram, a pie chart, or the like), and/or a combination of textual and graphical formats.

In some implementations, intrusion detection platform 220 may rank the intrusion detection scores for all of the users in ascending order, descending order, or the like. In such implementations, intrusion detection platform 220 may provide, for display, a ranked list of the intrusion detection scores for all of the users. In some implementations, a user of intrusion detection platform 220 may select information associated with a particular user from the ranked list of the intrusion detection scores. Based upon the selection, intrusion detection platform 220 may provide, for display, detailed information associated with the particular user. The detailed information may include, for example, information provided in a user profile for the particular user, the intrusion detection score for the particular user, the threat scores for the particular user, or the like. In some implementations, intrusion detection platform 220 may compare an intrusion detection score for a particular user with a threshold, and may generate an alarm or a notification if the intrusion detection score satisfies the threshold.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

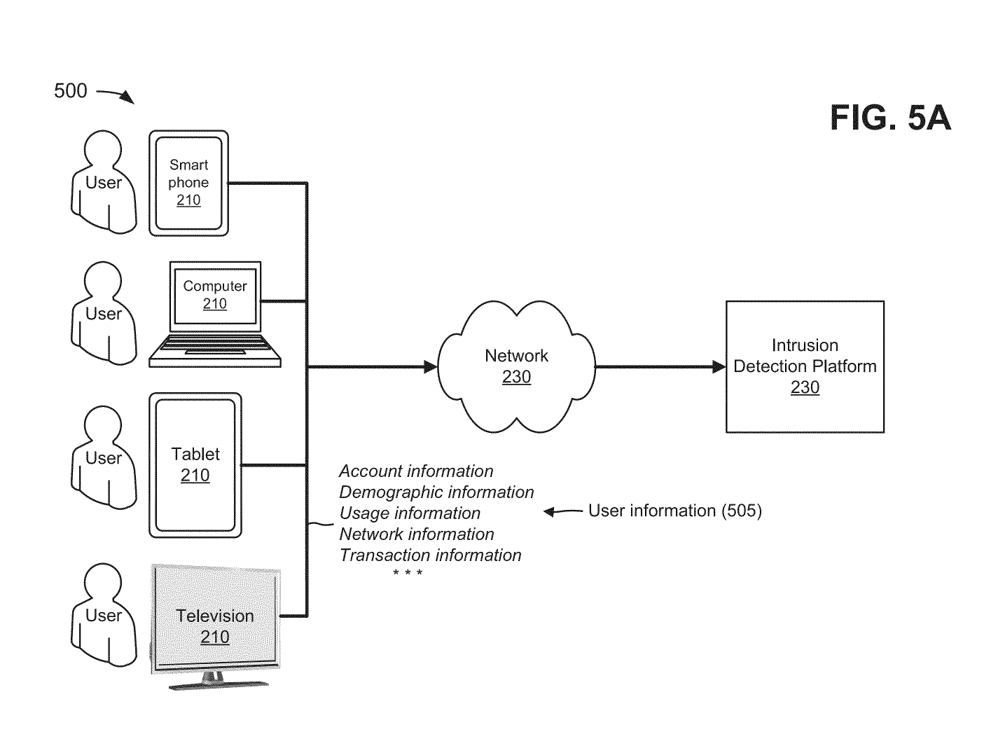

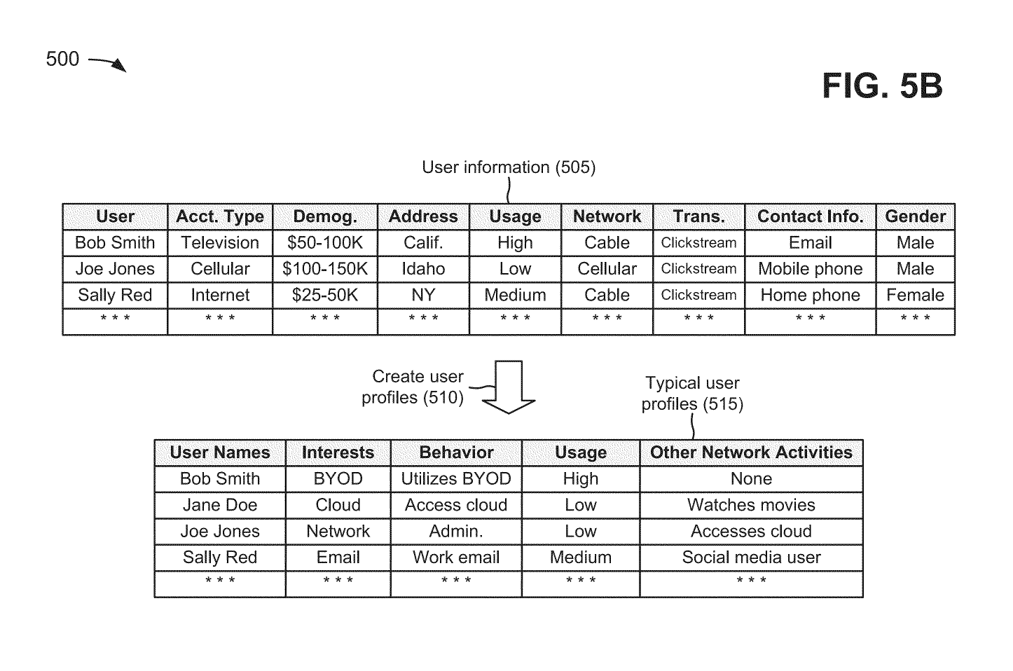

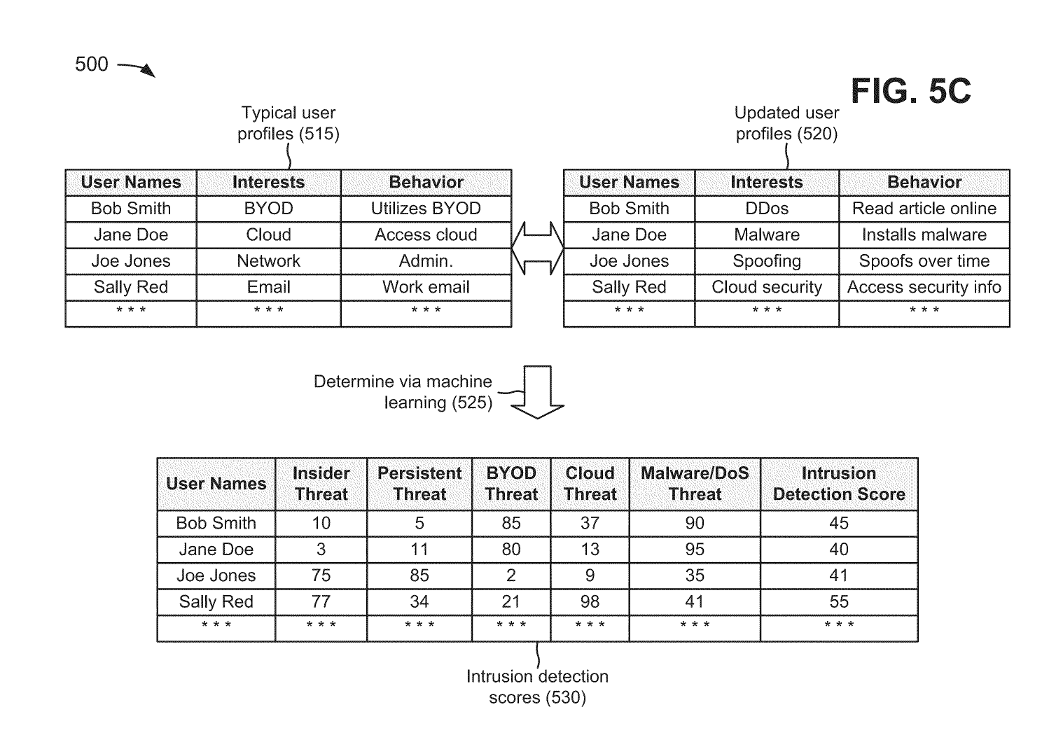

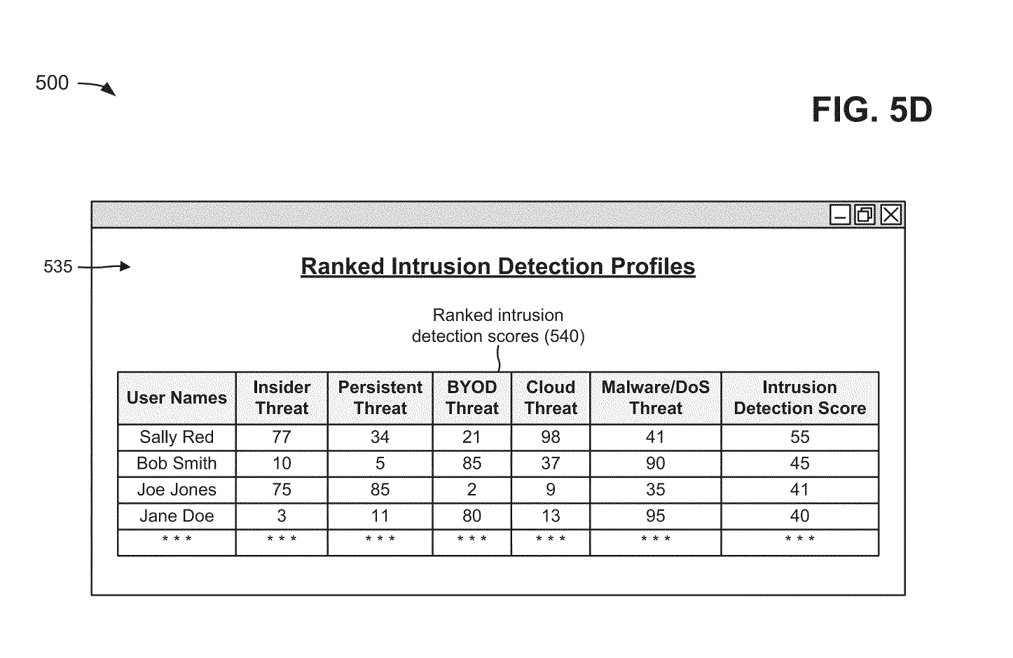

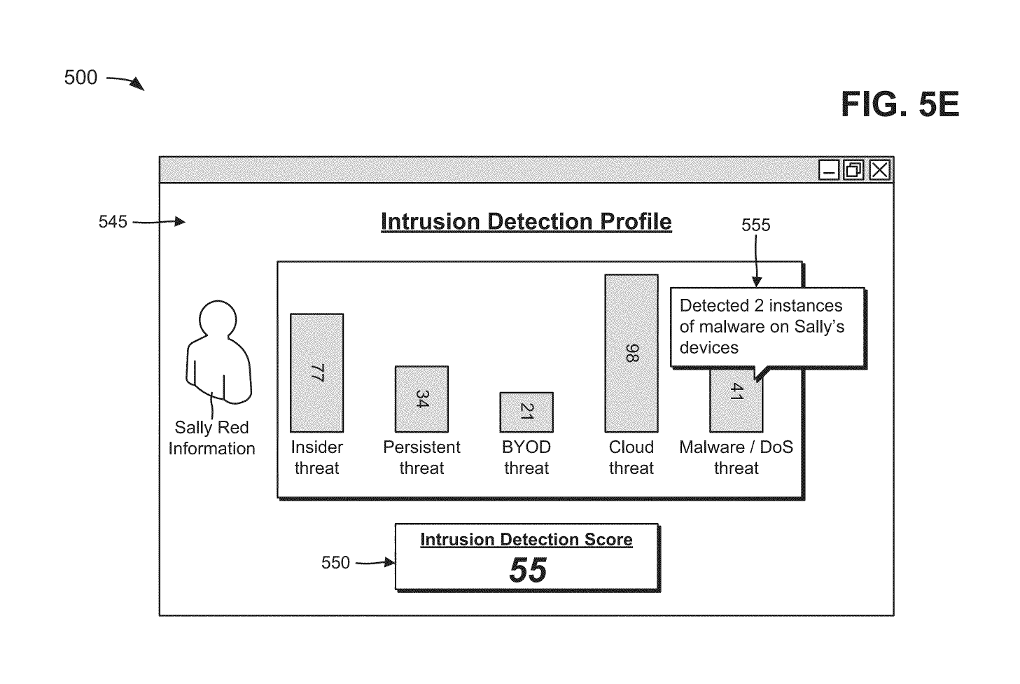

FIGS. 5A-5E are diagrams of an example 500 relating to example process 400 shown in FIG. 4. With reference to FIG. 5A, assume that users are associated with a variety of user devices 210 (e.g., smart phones, computers, tablets, televisions, or the like) that provide user information 505. User information 505 may include information associated with user devices 210 and the users (e.g., account information, demographic information, or the like); network information (e.g., information associated with network resources of network 230 utilized by user devices 210); network usage information associated with user devices 210; content accessed by user devices 210; transactions associated with user devices 210; clickstream information associated with user devices 210; location information associated with user devices 210; time information associated with user devices 210; or the like. User devices 210 may provide user information 505 to intrusion detection platform 220, and intrusion detection platform 220 may receive user information 505.

As shown in FIG. 5B, intrusion detection platform 220 may store user information 505 in a data structure (e.g., a tree, a table, a list, a database, or the like) that includes a user field, an account type field, a demographic field, an address field, a usage field, a network field, a transaction field, a contact information field, a gender field, and multiple entries associated with the fields. The user field may include information identifying the users of user devices 210, such as, for example, names, user identifiers, user account numbers, or the like. The account type field may include information identifying types of accounts associated with the users, such as, for example, a television service account, a cellular service account, an Internet service account, or the like. The demographic field may include information identifying demographics of the users, such as, for example, income levels of the users, education levels of the users, age, race, or the like. The address field may include information identifying home addresses of the users. The usage field may include information identifying network usage by the users, such as, for example, high network usage, medium network usage, low network usage, bandwidth utilization, or the like. The transaction field may include clickstream data associated with the users of user devices 210. The contact information field may include information identifying contact information (e.g., email addresses, mobile phone numbers, home phone numbers, or the like) for the users. The gender field may include information identifying genders (e.g., male versus female) of the users.

As indicated by reference number 510 in FIG. 5B, intrusion detection platform 220 may create typical user profiles 515 based on user information 505. A particular typical user profile 515, for a particular user, may include a user identifier and multiple attributes associated with the particular user (e.g., demographic information, location information, time information, user device information, network usage, behavior, or the like). As shown, intrusion detection platform 220 may store typical user profiles 515 in a data structure that includes a user names field, an interests field, a behavior field, a usage field, an other network activities field, and multiple entries associated with the fields. The user names field may include information identifying the names of the users of user devices 210, such as, for example, Bob Smith, Jane Doe, Joe Jones, Sally Red, or the like. The interests field may include information identifying interests of the users, such as, for example, BYOD usage, cloud usage, network usage, email usage, or the like. The behavior field may include information identifying behaviors of the users, such as, for example, utilizing a BYOD, accessing a cloud network, performing network administrator duties, utilizing a work email account, or the like. The usage field may include information identifying network usage by the users, such as, for example, high network usage, medium network usage, low network usage, bandwidth utilization, or the like. The other network activities field may include information identifying other network activities of the users, such as, for example, watching movies, accessing a cloud network, utilizing social media, or the like.

With reference to FIG. 5C, intrusion detection platform 220 may continuously receive updated user information 505 from user devices 210, and may generate updated user profiles 520 based on the updated user information 505, in a manner described above for typical user profiles 515. As further shown in FIG. 5C, intrusion detection platform 220 may compare typical user profiles 515 with corresponding updated user profiles 520. For example, intrusion detection platform 220 may compare typical user profile 515 of Bob Smith with updated user profile 520 of Bob Smith. During the comparison of typical user profiles 515 and updated user profiles 520, intrusion detection platform 220 may determine 525 (e.g., via machine learning) intrusion detection scores 530 for each of the users. Intrusion detection platform 220 may calculate threat scores (e.g., insider threat scores, advanced persistent threat scores, BYOD threat scores, cloud security threat scores, malware/DDoS/TDoS threat scores, or the like) for each of the users, and may determine intrusion detection scores 530 based on the threat scores. As shown, intrusion detection platform 220 may store the threat scores and intrusion detections scores 530 in a data structure that includes a user names field, an insider threat field, a persistent threat field, a BYOD threat field, a cloud threat field, a malware/DoS threat field, an intrusion detection score field, and multiple entries associated with the fields.

For example, intrusion detection platform 220 may determine threat scores, for a user (e.g., Bob Smith), based on a comparison of typical user profile 515 and updated user profile associated with Bob Smith. The determined threat scores may include an insider threat score (e.g., 10), an advanced persistent threat score (e.g., 5), a BYOD threat score (e.g., 85), a cloud security threat score (e.g., 37), a malware/DDoS/TDoS threat score (e.g., 90) associated with Bob Smith. Intrusion detection platform 220 may calculate intrusion detection score 530 for Bob Smith (e.g., 45) based on the determined threat scores (e.g., by averaging the threat scores together). Intrusion detection platform 220 may determine threat scores, for another user (e.g., Jane Doe), based on a comparison of typical user profile 515 and updated user profile associated with Jane Doe. The determined threat scores may include an insider threat score (e.g., 3), an advanced persistent threat score (e.g., 11), a BYOD threat score (e.g., 80), a cloud security threat score (e.g., 13), a malware/DDoS/TDoS threat score (e.g., 95) associated with Jane Doe. Intrusion detection platform 220 may calculate intrusion detection score 530 for Jane Doe (e.g., 40) based on the determined threat scores. Intrusion detection platform 220 may continue this process until intrusion detection scores 530 are determined for all of the users.

With reference to FIG. 5D, intrusion detection platform 220 may rank the users based on intrusion detection scores 530. For example, intrusion detection platform 220 may rank a user (e.g., Sally Red) associated with a greatest intrusion detection score 530 first, a user (e.g., Bob Smith) associated with a next greatest intrusion detection score 530 second, or the like. Intrusion detection platform 220 may generate a user interface 535 that includes a ranked list of users based on intrusion detection scores 530, as indicated by reference number 540. Intrusion detection platform 220 may provide user interface 535 for display to a user associated with intrusion detection platform 220. The user may select one of the users in ranked list 540 in order to view detailed information associated with the selected user. In some implementations, intrusion detection platform 220 may group users (e.g., by location, department, access point, or the like), and may generate intrusion detection scores for groups of users. In such implementations, a user of intrusion detection platform 220 may drill down a group of users to see user-level information.

For example, assume that the user selects Sally Red from ranked list 540. Based on the selection, intrusion detection platform 220 may retrieve (e.g., from storage) information associated with Sally Red, and may generate a user interface 545 that includes an intrusion detection profile for Sally Red, as shown in FIG. 5E. Intrusion detection platform 220 may provide user interface 545 for display to the user associated with intrusion detection platform 220. As further shown in FIG. 5E, user interface 545 may include an image of Sally Red, information associated with a user profile of Sally Red, threat scores (e.g., an insider threat score, an advanced persistent threat score, a BYOD threat score, a cloud security threat score, and a malware/DDoS/TDoS threat score) for Sally Red, and an intrusion detection score 550 for Sally Red. If the user of intrusion detection platform 220 hovers over or selects a particular threat score, user interface 555 may provide further information associated with the particular threat score (e.g., “Detected 2 instances of malware on Sally's devices”), as indicated by reference number 555. Information provided by user interfaces 535 and 545 may enable an administrator of network to quickly and easily identify and eliminate threats to a network, which may provide significant cost savings a provider of the network.

As indicated above, FIGS. 5A-5E are provided merely as an example. Other examples are possible and may differ from what was described with regard to FIGS. 5A-5E.

Systems and/or methods described herein may provide an intrusion detection platform that addresses multiple network security threats for each user of a network based on usage of the network. The systems and/or methods may discover threats and vulnerabilities at a user level, a user device level, a network level, a sub-network level, a system level, or the like through automated discovery of anomalies associated with network usage. The systems and/or methods may enable vulnerability discovery, assessment, threat detection, and behavioral monitoring through data mining of network usage patterns. By preventing network security threats, the systems and/or methods may provide cost savings to entities associated with a network.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The foregoing disclosure provides illustration and description, but is not intended to be exhaustive or to limit the implementations to the precise form disclosed. Modifications and variations are possible in light of the above disclosure or may be acquired from practice of the implementations.

A component is intended to be broadly construed as hardware, firmware, or a combination of hardware and software.

User interfaces may include graphical user interfaces (GUIs) and/or non-graphical user interfaces, such as text-based interfaces. The user interfaces may provide information to users via customized interfaces (e.g., proprietary interfaces) and/or other types of interfaces (e.g., browser-based interfaces, or the like). The user interfaces may receive user inputs via one or more input devices, may be user-configurable (e.g., a user may change the sizes of the user interfaces, information displayed in the user interfaces, color schemes used by the user interfaces, positions of text, images, icons, windows, or the like, in the user interfaces, or the like), and/or may not be user-configurable. Information associated with the user interfaces may be selected and/or manipulated by a user (e.g., via a touch screen display, a mouse, a keyboard, a keypad, voice commands, or the like).

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A method, comprising:
receiving, by a device, user information associated with users of user devices,
the user devices being associated with a network,
the user information being received from one or more network resources of the network and from the user devices;
creating, by the device, user profiles, associated with the users, based on the user information,
the user profiles being associated with different attributes associated with the users;
determining, by the device, threats to the network based on the user profiles,
the threats to the network including:
insider threats to the network by the users,
advanced persistent threats to the network by the users,
bring your own device (BYOD) threats to the network by the users,
cloud security threats to the network by the users,
malware threats to the network by the users, and
denial of service (DoS) threats to the network by the users;
assigning, by the device, a first plurality of weights to the different attributes associated with the user profiles;
calculating, by the device, threat scores for the threats to the network, for each user, of the users, based on the assigned first plurality of weights;
assigning, by the device, a second plurality of weights to the calculated threat scores;
calculating, by the device, an intrusion detection score for each user, of the users, based on the calculated threat scores and the assigned second plurality of weights;
ranking, by the device, the users, based on the calculated intrusion detection scores for the users, to create a ranked list of users; and
providing, by the device and for display, the ranked list of users.

2. The method of claim 1, further comprising:
generating an intrusion detection profile for a user, of the users; and
providing, for display, the intrusion detection profile.

3. (canceled)

4. The method of claim 1, where a first weight, of the first plurality of weights, assigned to one of the insider threats, the advanced persistent threats, the BYOD threats, the cloud security threats, the malware threats, or the DoS threats, is different than a second weight, of the first plurality of weights, assigned to another one of the insider threats, the advanced persistent threats, the BYOD threats, the cloud security threats, the malware threats, or the DoS threats.

5. The method of claim 1, where determining the threats to the network, comprises:
utilizing the user profiles in a machine learning algorithm; and
solving the machine learning algorithm, based on the user profiles, to determine the insider threats, the advanced persistent threats, the BYOD threats, the cloud security threats, the malware threats, and the DoS threats.

6. The method of claim 1, further comprising:
creating first user profiles, associated with the users, based on the user information;
receiving updated user information; and
creating second user profiles, associated with the users, based on the updated user information; and
where determining the threats to the network comprises:
comparing the second user profiles and a set of user profiles to determine the insider threats, the advanced persistent threats, the BYOD threats, the cloud security threats, the malware threats, and the DoS threats.

7. (canceled)

8. A system, comprising:
one or more devices to:
receive user information associated with a user of a user device,
the user device being associated with a network,
the user information being received from one or more network resources of the network and from the user device;
create a user profile, associated with the user, based on the user information,
the user profile being associated with different attributes associated with the user;
determine threats to the network, by the user, based on the user profile,
the threats to the network including:
insider threats,
advanced persistent threats,
bring your own device (BYOD) threats,
cloud security threats,
malware threats, and
denial of service (DoS) threats;
assign a first plurality of weights to the different attributes associated with the user profile;
calculate threat scores for the threats to the network, for the user, based on the assigned first plurality of weights;
assign a second plurality of weights to the calculated threat scores;
calculate an intrusion detection score for the user;
rank the user, among a plurality of users, based on the calculated intrusion detection score to create a ranked list of users; and
present, for display, the ranked list of users.

9. The system of claim 8, where the one or more devices are further to:
generate an intrusion detection profile for the user; and
provide, for display, the intrusion detection profile.

10. (canceled)

11. The system of claim 8, where
a first weight, of the first plurality of weights, assigned to one of the insider threats, the advanced persistent threats, the BYOD threats, the cloud security threats, the malware threats, or the DoS threats, is different than a second weight, of the first plurality of weights, assigned to another one of the insider threats, the advanced persistent threats, the BYOD threats, the cloud security threats, the malware threats, or the DoS threats.

12. The system of claim 8, where, when determining the threats to the network, the one or more devices are to:
utilize the user profile in a machine learning algorithm; and
solve the machine learning algorithm, based on the user profile, to determine the threats to the network.

13. The system of claim 8, where the one or more devices are further to:
create a first user profile, associated with the user, based on the user information;
receive updated user information; and
create a second user profile, associated with the user, based on the updated user information; and
when determining the threats to the network, the one or more devices are to:
compare typical user profiles and the second user profile to determine the threats to the network.

14. (canceled)

15. A non-transitory computer-readable medium storing instructions, the instructions comprising:
one or more instructions that, when executed by one or more processors of a device, cause the one or more processors to:
receive user information associated with users of user devices,
the user devices being associated with a network,
the user information being received from one or more network resources of the network and from the user devices;
create user profiles, associated with the users, based on the user information,
the user profiles being associated with different attributes associated with the users;
determine threats to the network, by the users, based on the user profiles,
the threats to the network including:
insider threats,
advanced persistent threats,
bring your own device (BYOD) threats,
cloud security threats,
malware threats, or
denial of service (DoS) threats;
assign a first plurality of weights to the different attributes associated with the user profiles;
calculate threat scores for the threats to the network, for each user, of the users, based on the assigned first plurality of weights;
assign a second plurality of weights to the calculated threat scores;
calculate an intrusion detection score for each user, of the users, based on the calculated threat scores and the assigned second plurality of weights;
rank the users, based on the calculated intrusion detection scores for the users, to create a ranked list of users; and
store the ranked list of users.

16. The non-transitory computer-readable medium of claim 15, where the one or more instructions, when executed by the one or more processors, further cause the one or more processors to:
generate an intrusion detection profile for a user, of the users; and
provide, for display, the intrusion detection profile.

17. (canceled)

18. The non-transitory computer-readable medium of claim 16, where the one or more instructions, when executed by the one or more processors, further cause the one or more processors to:
receive a selection of a particular user from the ranked list of users; and
provide, for display and based on the selection, information associated with the particular user.

19. The non-transitory computer-readable medium of claim 15, where the one or more instructions, when executed by the one or more processors, further cause the one or more processors to:
determine whether any of the intrusion detection scores satisfy a threshold; and
generate an alarm or a notification when any of the intrusion detection scores satisfy the threshold.

20. The non-transitory computer-readable medium of claim 15, where the one or more instructions, when executed by the one or more processors, further cause the one or more processors to:
present for display the intrusion detection scores for one or more of the users; and
present for display the information associated with the threats to the network associated with the one or more of the users.

21. The non-transitory computer-readable medium of claim 15, where the one or more instructions, when executed by the one or more processors, further cause the one or more processors to:
create first user profiles, associated with the users, based on the user information;
receive updated user information; and
create second user profiles, associated with the users, based on the updated user information; and
where the one or more instructions, that cause the one or more processors to determine the threats to the network, cause the one or more processors to:
compare the second user profiles to a set of user profiles to determine the insider threats, the advanced persistent threats, the BYOD threats, the cloud security threats, the malware threats, and the DoS threats.

22. The non-transitory computer-readable medium of claim 15, where a first weight, of the first plurality of weights, assigned to one of the insider threats, the advanced persistent threats, the BYOD threats, the cloud security threats, the malware threats, or the DoS threats, is different than a second weight, of the first plurality of weights, assigned to another one of the insider threats, the advanced persistent threats, the BYOD threats, the cloud security threats, the malware threats, or the DoS threats.

23. The non-transitory computer-readable medium of claim 15, where the different attributes include at least one of:
demographic information,
time information, or
user device information.

24. The method of claim 1, further comprising:
determining whether any of the intrusion detection scores satisfy a threshold; and
generating an alarm or a notification when any of the intrusion detection scores satisfy the threshold.

25. The system of claim 8, where the one or more devices are further to:
determine whether the intrusion detection score satisfy a threshold; and
generate an alarm or a notification when the intrusion detection score satisfy the threshold.
